(19) United States
(12) Patent Application Publication
(10) Pub. No.: US 2002/0009565 A1
(43) Pub. Date: Jan. 24, 2002

(54) Container with improved surface fracture resistance

(76) Inventor: Gregory M. Fehn, Diamond Lake, IL (US)

Correspondence Address: Eugene F. Friedman, Monadnock Building -- Suite 1633, 53 West Jackson Boulevard, Chicago, IL, 60604, US

(21) Appl. No.: 09/859,022

(22) Filed: May 15, 2001

Related U.S. Application Data
(60) Provisional application No. 60/209,905, filed on Jun. 7, 2000.

(51) Int. Cl. B32B 1/02

(52) U.S. Cl. 428/36.7; 428/35.4

(57) ABSTRACT

A plastic container having a thin outer layer that protects against stress concentration effects arising from either surface irregularities or flexing when dropped and a method of making that container. The outer layer helps avoid bottle failure resulting from cracks that start at such areas of stress. The outer layer may incorporate both the stress inducing irregularities and the properties to minimize possible, resulting catastrophes. The surface irregularities giving birth to stress include edges of in-mold-applied labels, ridges, stippling, and grip bumps. Dropping the container gives rise to flexing which can also induce stress concentrations. The outer layer, to accomplish the protective function, should display lesser brittleness or, in some cases, lesser density than the bulk of the container wall. Making the container involves forming the bulk of the wall with a first, inner, structural plastic. A thin layer displaying lesser brittleness or, in some cases, lesser density is formed as the container's outer layer.

### BACKGROUND

Plastic containers have become useful, dependable, and consequently ubiquitous in modem society. Their very success, however, has resulted in demands for their continuing improvement. The impetus underlying the research and developmental efforts derive from three separate concerns. These include the economic, ergonomic, and environmental impacts of and aspirations for these containers.

The in-mold labeling of containers constituted a major improvement in the manufacture and use of plastic containers. This advance accomplishes two tasks in one processing step with substantial aesthetic and economic savings. The amounts of resins used in containers regularly undergo reductions. This effort, by itself, accomplishes both economic and environmental benefits.

Plastic containers now also possess features not seen in the early years of their use. Incorporating ridges may provide structural strength and rigidity especially in thin-walled bottles. They can also enhance the appearance and grippability and provide graphic and alphanumeric information. Similarly, placing bumps on the surface may similarly avoid their slipping out of the users' hands. All of these surface treatments, as well as many others, can provide the containers with a pleasing esthetic appearance and improved functionality.

Not surprisingly, however, plastic bottles are susceptible to outside influences resulting in the development of leaks, cracks, and other undesirable losses of complete integrity. The developments discussed above, by either decreasing the amount of plastic in a container and thus the container's wall thickness or by incorporating deviations from absolutely smooth walls, have aggravated the likelihood for container failure. While not posing any question as to the superiority and desirability of plastic bottles over other containers, they do pose a challenge to manufacturers to develop even better products for their customers and, of course, the ultimate consumers of the product.

In particular, Gregory M. Fehn, in his U.S. Pat. No. 5,814,383, issued Sep. 29, 1998, realized that occasional failures of containers, especially those holding oil and stacked several layers upon each other, resulted from cracks that started at incipient creases in the containers' walls. He also discovered that applying a relatively thin layer of a particular type of resin on one or both sides of the container wall may obviate the disastrous cracking. In general, the additional, protective layer should display less stiffness or crease cracking than the bulk of the container wall. If the container's contents achieve a softening of the container's interior, then the container only requires a protective layer at the outer surface.

As with virtually any manufactured product, occasional problems continue to concern the companies producing plastic bottles. One such problem involves very occasional fracture and subsequent leakage through unexpected areas on the bottles' surfaces. Though happening with extremely low frequency, service to the purchasers and to the ultimate consumers strongly suggests the undertaking of efforts to ameliorate the problem.

### SUMMARY

The effort to understand, and hopefully reduce, the source of such surface fracturing now suggests that typical, important, and highly desirable features on the bottles' surfaces themselves create stress areas that can lead to leaks. These features may include the outline edges of the plastic that surround labels applied during the bottle's molding process. Stippling placed for its aesthetic appeal similarly can create surface stresses that carry the seeds of failures. Bumps and ridges employed for grippability may inadvertently produce the same result. Finally, identifying logos, graphics, or alphanumeric information molded into the container may lead to surface stress fracture. Similarly, dropping the container can cause flexing which, in turn, may possibly produce momentary or even long-term stress concentrations with concomitant surface fracturing.

Placing a carefully chosen, additional layer of plastic on or near the bottle's exterior surface portends the reduction of fracturing resulting from surface stress exploitation. In fact, the additional layer, when sitting on the surface, may include the very features giving rise to the stresses and the resulting failures. Although not necessary, incorporating the desirable features into a protective layer permits their continued use with a high reduction of adverse stress and failure.

In general, a container has a wall defining an interior and an exterior. To incorporate the protective layer, at least a part of the container's wall should have a plurality of layers. A first layer, generally lying toward, but not necessarily on, the interior has a composition of a thermoplastic polymer. A second layer lies toward or on the exterior of the container wall and occurs at the portion of the part of the wall which has the first layer. To provide its protective function, the second layer should prove less brittle than the first layer or, as an alternate criterion, have a density at least about 0.002 gm./cc. less than that of the first layer. The density difference may amount to 0.005 gm./cc. or more where both layers have a polyethylene composition. Where the less brittle layer lies on the exterior of the part of the container wall, it can include surface irregularities or, as an alternate criterion, areas of stress concentration that give cause for concern.

Since it performs a protective function, the second layer will constitute less than about one half of the thickness of the part of the wall where it occurs. Alternately, the first or inner layer, since it generally provides the structural strength of a container, will constitute more than about one tenth of thickness of the entire part of the wall where the multiple layers occur.

The second layer can achieve a similar protective function in those situations where it does not lie on the actual exterior of the container wall. In this situation, the second layer typically will not incorporate areas of stress concentration or surface irregularities. However, it will continue to show either less brittleness or a density at least about 0.002 gm./cc. less than the first layer.

A method for making a container with the protective layer involves molding a container with the wall defining an interior and exterior. Generally, the molding process includes forming a first thermoplastic layer of at least part of the wall. It also includes forming, at that part of the wall with the first layer, a second thermoplastic layer. The second layer occurs toward the exterior of the container where the first layer exists. The two layers thus formed should display at least one of the sets of characteristics described above for the container.

### BRIEF DESCRIPTION OF THE FIGURES

FIG. 1 gives a cross-sectional view of a container made with two layers of plastic with the outer layer incorporating stress concentrating areas induced by surface irregularities in the form of gripping bumps but also serving to protect the container wall from incipient cracks resulting from such irregularities.

FIG. 2 provides an enlarged view of the layers of plastic forming the container of FIG. 1 in an area of surface irregularities.

FIG. 3 shows, in a cross-sectional view, a container wall similar to that of FIG. 2 but where in-mold labeling has created irregularities on the container surface.

FIG. 4 gives a cross-sectional view of a container wall similar to that of FIG. 3 but including an extra layer of reground plastic.

FIG. 5 shows, in cross-sectional view, a plastic container wall which, although not incorporating surface irregularities, sandwiches a protective layer similar to that of the prior figures between two layers of plastic.

FIG. 6 provides a cross-sectional view of a portion of a container wall having an outer protective layer, an oxygen barrier layer with adhesive layers, and a layer of reground plastic.

### DETAILED DESCRIPTION

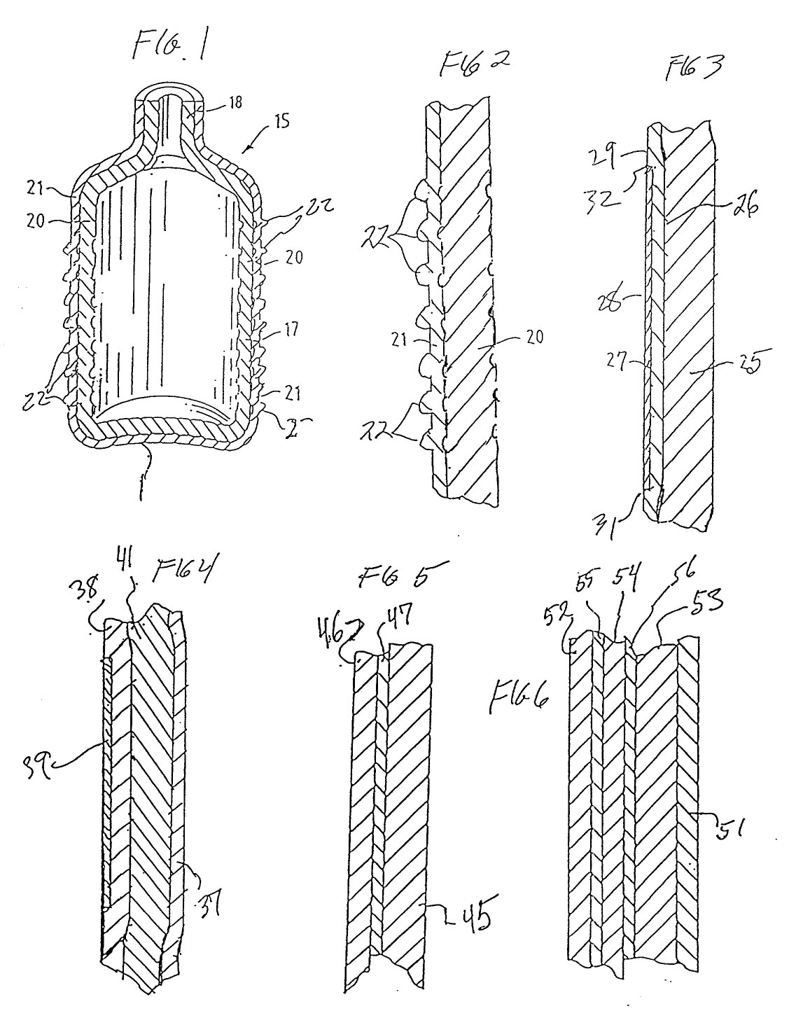

FIG. 1 shows a container generally at 15 that will alleviate failures caused by stresses originating at surface irregularities. The container 15 includes the bottom 16, the side 17, and the neck 18 at the top. As seen in FIGS. 1 and 2, the construction of the container 15 utilizes the thicker interior layer 20 covered by the thinner exterior layer 21. The gripping bumps 22, shown in exaggerated size, form part of the exterior layer 21.

The container-wall portion shown FIG. 3 appears similar to that of FIGS. 1 and 2 in that it has the inner layer of plastic 25 with a thinner outer layer of plastic 26. Rather than the gripping bumps 22, the container wall portion of FIG. 3 includes the label 27 applied during the actual molding of the container itself. The process of in-mold labeling commences with the placement of an actual label 27 inside the mold and against its wall prior to the insertion of any plastic material. A vacuum applied to small holes in the mold wall serve to hold the label 27 in place during the subsequent bottle-molding process. The result appears very similar to that shown in FIG. 3 in which the exterior surface 28 of the label 27 forms a continuous plane with the exterior surface 29 of the outer plastic layer 26.

Naturally, in-mold labeling constitutes a very significant improvement in the process of manufacturing plastic containers. However, careful study and extensive thought now suggest that the process itself may result in stress concentrating areas on the container's surface that may result in disturbing failures. Fortunately, the frequency with which this has occurred remained sufficiently low that it clearly did not outweigh the benefits of in-mold labeling,

Returning to FIG. 3, the molten plastic of the outer layer 26, during the molding of the container, flows around and adjacent to the label 27. This produces the irregularities 31 and 32 in the outer layer 26 at the outer edges of the label 27. These irregularities 31 and 32 have the potential of creating very substantial surface stress concentrations. On occasion, these stress concentrations can result in surface failures. In the simple two-layer container walls of FIGS. 2 and 3, the bumps 22 in the former and the irregularities 31 and 32 resulting from the in-mold labeling in the latter can create localized surface stress concentrations that may lead, if untreated, to failures permitting the egress of the container's contents. However, the selection of the appropriate resins, especially for the outer layer 21 or 26, can reduce the occurrence of such failures. Thus, the outer layer 21 or 26 may display less brittleness than the inner layers 20 or 25, respectively. This lower brittleness helps to prevent stresses from developing into cracks and to keep cracks, when created, from spreading and causing failures.

The protective layers 21 and 26 do not provide the primary structural strength of the container of which they form part. There, they should typically constitute less than about one half of the wall thickness where they occur. More typically, the protective layer will provide even less than half of the wall thickness which may decrease to fourth tenths, one quarter, one tenth, or even less of the wall thickness.

The inner layers 20 and 25 provide the main structural strength and rigidity of the containers. They should have at least one tenth of the container's thickness. Normally, the inner or strength layers 20 and 25 will constitute at least about five tenths, six tenths, three quarters or even more of the wall thickness.

Alternately, with containers made from some thermoplastic polymers such as polyethylene or polypropylene, the relative densities between the protective layers 21 and 26 compared to the other layers may indicate that they will perform the desired functions. The term “polyethylene” refers to ethylene homopolymers and copolymers and multiphasic blends of these with other polymers. A similar definition applies to the word “polypropylene.”

In referring to containers having layers with differential densities, the structural layers 20 and 25 should constitute at least one tenth of the wall thickness and the protective layers 21 and 26 less than about half of the wall thickness. Where the protective and structural layers each has a composition of a polyethylene or a polypropylene, a density difference of at least 0.002 gm./cc. may, dependent upon the specific compositions of the two layers, suffice for this purpose. The differential of at least 0.002 gm./cc. has particular applicability where the structural and protective layers both contain some form of polypropylene.

For polyethylene as the plastic in the protective layer, utilizing a resin with a density of at least about 0.005 gm./cc. less than the structural layer will help minimize the development and propagation of cracks resulting from surface irregularities. While this density difference of 0.005 gm./cc. provides some protective function with polyethylene, even greater density differentials may result in greater assurance. Thus, the inner layers 21 and 26 may have a density less than that of the structural layers 20 and 25, respectively, of 0.010 gm./cc. or even 0.015 gm./cc.

Naturally, these relative densities have their greatest significance where the inner layers 20 and 25 and the outer layers 21 and 26, respectively, have a similar chemical composition. Stated in other words, although the layers do not exactly have the same composition as indicated by the difference in densities, they may most conveniently derive from resins employing generally the same monomers. In particular, polyethylene used for the two layers but having different densities provides the desired protection against surface stress propagation. The higher densities of the inner layers 20 and 25 gives them their greater structural strength while the lower densities for the outer layers 21 and 26 helps keep the surface stresses from producing failures. High density polyethylene (HDPE) homopolymer in particular provides a structurally strong and rigid inner layer 20 or 25, while HDPE copolymers may impart good stress properties in the outer layer. Where both layers have a composition of a polyethylene, the protective layer may appear softer than the structural layer.

As suggested above, the protective and structural layers need not have the same composition nor even derive generally from the same monomer. For example, where the structural layer includes a polypropylene, the protective layer may be a polypropylene or a polyethylene.

The container 15 of FIG. I employs the dual layer structure 20 and 21 over its entire extent. However, the gripping bumps 22 of FIGS. 1 and 2 or the label 27 of FIG. 3 generally occur in localized areas of the container. As a result, the protective layers 21 and 26 might only occur in those areas of the container possessing the surface stress features. Or, some areas of the container may prove more susceptible to receiving the stresses of a bottle's falling on the floor; in these instances, only the portions of the container that may fail need enjoy the security of the protective layer. Naturally, if the container does not have the dual-layer structure throughout, then the juncture between the locations with and without the protective layers 21 and 26 themselves should have a conformation that will avoid the development of separate surface stresses. The use of the dual layer structure throughout the container 15 naturally avoids this problem. Furthermore, in the usual manufacturing techniques often employed when making the container, coextruding the layers 20 and 21 of FIGS. 1 and 2 or the layers 25 and 26 of FIG. 3 over the entire container proceeds most facilely.

The sections of container wall seen in FIGS. 4 to 6 incorporate additional layers for different purposes. Yet, as discussed immediately below, they all contain a layer responding to the requirements given above for avoiding failures resulting from surface stress concentrations. Thus, the container wall in FIG. 4 includes the usual inner, structural layer 37, and the outer layer 38 which includes the label 39 incorporated during the in-mold labeling process. The surface stresses created by the placement of the label 39 remain in the outer layer 38 in the same fashion as seen in FIG. 3. Between the inner layer 37 and the outer layer 38 sits the middle layer 41 which can utilize reground scrap produced from flash and other material of prior moldings.

As a specific example, the inner layer 37 may take the form of Phillips 6007 polyethylene homopolymer having a density of 0.963 gm./cc. The outer layer 38 may derive from Paxon 40-003 copolymer material of polyethylene, and providing it with a density of 0.940 gm./cc., allows it to absorb the surface stresses resulting from the inclusion of the label 39 during the molding process. The outer layer 38 may also include the colorant, in three percent, of Breen 940 also having a density of 0.940 gm./cc. To simulate a typical regrind, the middle layer 41 may include both the Phillips 6007 homopolymer of polyethylene used as the inner layer 37 (69 percent), the Paxon 40-003 copolymer (28 percent) with its dosage of colorant Breen 940 (three percent) used for the outer layer 38. The relative thicknesses of the layers provide the inner layer 37 with approximately 10 percent of the weight of the wall, the outer layer 38 has approximately 20 percent of the weight of the wall, and the simulated regrind layer 41 provides the remaining 70 percent of the wall weight. The use of the low density polymer for the outer layer 38 has the purpose of reducing the in-mold labeling edge-impact failure sensitivity.

The container wall of FIG. 5 also possesses three layers none of which displays any intentionally placed surface irregularities. The inner layer 45 provides the structural strength and rigidity. This may serve to protect against stresses developed if the bottle is dropped from an appreciable height. Alternately the container may include some sort of surface stress concentration located elsewhere in its outer layer 46 but not shown in FIG. 5. In either case, the outer layer 46 may have functions in the container that do not permit the choice of a resin which will absorb surface stress concentrations. In this instance, the inner layer 47 may help absorb the surface stress concentrations in addition to the outer layer 46. In effect, the middle layer 47 helps insulate the structural layer 45 from cracks or other failures generated by surface stresses in the outer layer 46. To accomplish this objective, the middle layer 47 would typically display the characteristics of the outer layers 21, 26, and 38 of the prior figures.

The container wall of FIG. 6 includes the layers of the less complex wall of FIG. 4. Thus, its inner layer 51 incorporates a virgin resin that will contact the bottle's contents. The outer layer 52 again has some feature that produces surface stress concentrations or may suffer surface stress concentration when dropped. In this case, it also displays the characteristics discussed above for absorbing the stress concentrations and preventing their propagation throughout the container wall to create failures. The thicker layer 53 permits the utilization of reground resin derived from plastic produced in prior moldings and either not actually required for the final container or possibly from containers not meeting specification and then recycled. The three layers 51 to 53 of course appear in the container wall of FIG. 4. However, FIG. 6 also shows the utilization of a barrier layer 54 that will prevent or at least retard the passage of gas.

In many instances, the oxygen in air may deleteriously affect the contents that the bottle will hold. In this instance, the barrier layer 54 may have a composition of ethylene vinyl alcohol copolymer (“EVOH”) which has found widespread use as a barrier layer in plastic containers. To guard against the delamination of the sundry layers, the container wall of FIG. 6 includes the adhesive layers 55 and 56 which attach the barrier layer 54 to its surrounding layers 52 and 53, respectively.

A specific construction for the container wall of FIG. 6 may incorporate an inner layer 51 having a composition of virgin homopolymer polyethylene with a density of 0.960 gm./cc. or even greater. This layer may constitute approximately 20 percent of the overall wall thickness. The regrind layer 53, providing about 55 percent of the wall thickness, may have a composition of 50 percent reground trim-with the other 50 percent provided by virgin polyethylene of density of 0.955 gm./cc. The outer, or protective, layer 52 may take the form of virgin polyethylene with a density of 0.955 gm./cc. Its lower density compared to the inner layer 51 protects the container from failures caused by surface stress concentrations. It may constitute approximately 20 percent of the wall thickness. The remaining sandwich layer of adhesive 55, EVOH 54, and adhesive 56 would constitute the remaining five percent of the wall thickness.

This structure of FIG. 6 actually permits the use of stronger, higher density polyethylene (HDPE) resins or high stiffness polypropylene resins as its inner layer 51 as well as portions of the reground layer 53 and the outer layer 52 which may include some reground material. This construction permits an overall thinner container wall utilizing less plastic but producing the same strength as prior, thicker container walls. The exterior, protective layer 52 helps prevent the progression of surface stress concentrations into container failures.

A container wall having a similar structure to that discussed above for FIG. 6 may extend the differences between the various layers. Thus, the inner layer 51 may include an HDPE with the density of at least, and preferably greater than, 0.960 gm,/cc. The outer, protective layer 52 may include the virgin lower density polyethylene having a density of 0.950 gm./cc., 0.940 gm./cc., or lower. This polyethylene may constitute 50 percent of the outer layer 52 with the remainder of that layer derived from reground material The middle layer 53 may have a composition of one half of reground trim while the remaining one half utilizes virgin polyethylene having a higher density of 0.960 gm./cc. The EVOH sandwich of the layers 54 to 56 would remain the same. The higher density of the inner layer 51 and the reground layer 53 provide a container with the same or even higher structural strength while the lower density of the outer layer 52 protects against failures resulting from surface stresses.

Accordingly, what is claimed is:

1. A container having a wall defining an interior and an exterior, at least a part of said wall comprising a plurality of layers including:
(A) a first thermoplastic layer; and
(B) a second thermoplastic layer less brittle than said first layer, said second layer occurring at the portion of said part of said wall wherever said first layer occurs and being located, at said portion, toward the exterior of said container from said layer, said second layer comprising less than about one half of the thickness of said part of said wall.

2. The container of claim 1 wherein said first layer includes a polypropylene.

3. The container of claim 2 wherein said second layer includes a polyethylene or a polypropylene.

4. The container of claim 3 wherein said second layer includes a copolymer of ethylene or a copolymer of propylene.

5. The container of claim 3 wherein said second layer includes a copolymer of ethylene.

6. The container of claim 3 wherein said second layer includes a polypropylene.

7. The container of claim 3 wherein said second layer includes a polyethylene.

8. The container of claim 1 wherein said first layer includes a polyethylene.

9. The container of claim 8 wherein said second layer includes a polyethylene.

10. The container of claim 9 wherein said polyethylene of said first layer constitutes a high density polyethylene.

11. The container of claim 1 wherein said first and second layers are coextruded together.

12. The container of claim 11 wherein said second layer constitutes the exterior layer of said part of said wall.

13. The container of claim 12 wherein said first layer constitutes the inner layer of said part of said wall.

14. The container of claim 13 wherein said first and second layers constitute substantially all of said part of said wall.

15. The container of claim 13 further including an oxygen barrier layer between said first and second layers.

16. The container of claim 15 wherein said barrier layer comprises ethylene vinyl alcohol copolymer.

17. The container of claim 16 further comprising a first adhesive layer on one side of said barrier layer and a second adhesive layer on the other side of said barrier layer.

18. The container of claim 17 wherein said barrier layer and said first and second adhesive layers comprise no more than about five percent of the thickness of said part of said wall.

19. The container of claim 12 wherein said second layer is softer than said first layer.

20. The container of claim 19 wherein one of the layers of said part of said wall other than said first layer includes a reground thermoplastic.

21. The container of claim 11 wherein said first layer has a density of at least about 0.960 gm./cc.

22. The container of claim 21 wherein said second layer has a density of at least about 0.005 gm./cc. less than said first layer.

23. The container of claim 22 wherein said first layer comprises at least about 60 percent of the thickness of said part of said wall.

24. The container of claim 23 wherein said second layer comprises no more than about 25 percent of the thickness of said part of said wall.

25. The container of claim 24 wherein said second layer has a density at least about 0.010 gm./cc. less than said first layer.

26. The container of claim 25 wherein said first layer comprises at least about 75 percent of the thickness of said part of said wall.

27. The container of claim 26 wherein said second layer comprises no more than about 10 percent of the thickness of said part of said wall.

28. The container of claim 27 wherein said second layer has a density at least about 0.015 gm./cc. less than said first layer.

29. A container having a wall defining an interior and an exterior, at least a part of said wall comprising a plurality of layers including:
(A) a first thermoplastic layer; and
(B) a second thermoplastic layer less brittle than said first layer, said second layer occurring at the portion of said part of said wall wherever said first layer occurs and being located, at said portion, toward the exterior of said container from said first layer, said first layer comprising more than about one tenth of the thickness of said part of said wall.

30. The container of claim 29 wherein said first layer includes a polypropylene.

31. The container of claim 30 wherein said second layer includes a polyethylene or a polypropylene.

32. The container of claim 31 wherein said second layer includes a copolymer of ethylene or a copolymer of propylene.

33. The container of claim 31 wherein said second layer includes a copolymer of ethylene.

34. The container of claim 31 wherein said second layer includes a polypropylene.

35. The container of claim 31 second layer includes a polyethylene.

36. The container of claim 29 wherein said first layer includes a polyethylene.

37. The container of claim 36 wherein said second layer includes a polyethylene.

38. The container of claim 37 wherein said polyethylene of said first layer constitutes a high density polyethylene.

39. The container of claim 29 wherein said first and second layers are coextruded together.

40. The container of claim 39 wherein said second layer constitutes the exterior layer of said part of said wall.

41. The container of claim 40 wherein said first layer constitutes the inner layer of said part of said wall.

42. The container of claim 41 wherein said first and second layers constitute substantially all of said part of said wall.

43. The container of claim 42 further including an oxygen barrier layer between said first and second layers.

44. The container of claim 43 wherein said barrier layer comprises ethylene vinyl alcohol copolymer.

45. The container of claim 44 further comprising a first adhesive layer on one side of said barrier layer and a second adhesive layer on the other side of said barrier layer.

46. The container of claim 45 wherein said barrier layer and said first and second adhesive layers comprise no more than about five percent of the thickness of said part of said wall.

47. The container of claim 40 wherein said second layer is softer than said first layer.

48. The container of claim 47 wherein one of the layers of said part of said wall other than said first layer includes a reground thermoplastic.

49. The container of claim 39 wherein said first layer has a density of at least about 0.960 gm./cc.

50. The container of claim 49 wherein said second layer has a density of at least about 0.005 gm./cc. less than said first layer.

51. The container of claim 50 wherein said first layer comprises at least about 50 percent of the thickness of said part of said wall.

52. The container of claim 51 wherein said second layer comprises no more than about 25 percent of the thickness of said part of said wall.

53. The container of claim 52 wherein said second layer has a density at least about 0.010 gm./cc. less than said first layer.

54. The container of claim 52 wherein said first layer comprises at least about 60 percent of the thickness of said part of said wall.

55. The container of claim 54 wherein said second layer comprises no more than about 10 percent of the thickness of said part of said wall.

56. The container of claim 52 wherein said first layer comprises at least about 75 percent of the thickness of said part of said wall.

57. The container of claim 55 wherein said second layer has a density at least about 0.015 gm./cc. less than said first layer.

58. A container having a wall defining an interior and an exterior, at least a part of said wall comprising a plurality of layers including:
(A) a first thermoplastic layer; and
(B) a second thermoplastic layer less brittle than said first layer, said second layer occurring at the portion of said part of said wall wherever said first layer occurs and being located, at said portion, on the exterior of said container, said second layer including surface irregularities on said exterior.

59. The container of claim 58 wherein said first layer includes a polypropylene.

60. The container of claim 59 wherein said second layer includes a polyethylene or a polypropylene.

61. The container of claim 60 wherein said second layer includes a copolymer of polyethylene or a copolymer of polypropylene.

62. The container of claim 60 wherein said second layer includes a polyethylene.

63. The container of claim 60 wherein second layer includes a polypropylene.

64. The container of claim 60 wherein said second layer includes a polyethylene.

65. The container of claim 58 wherein said first layer includes a polyethylene.

66. The container of claim 65 wherein said second layer includes a polyethylene.

67. The container of claim 66 wherein s aid polyethylene of said first layer constitutes a high density polyethylene.

68. The container of claim 58 wherein said first and second layers are coextruded together.

69. The container of claim 68 wherein said first layer constitutes the inner layer of said part of said wall.

70. The container of claim 69 wherein said first and second layers constitute substantially all of said part of said wall.

71. The container of claim 69 further including an oxygen barrier layer between said first and second layers.

72. The container of claim 71 wherein said barrier layer comprises ethylene vinyl alcohol copolymer.

73. The container of claim 72 further comprising a first adhesive layer on one side of said barrier layer and a second adhesive layer on the other side of said barrier layer.

74. The container of claim 73 wherein said barrier layer and said first and second adhesive layers comprise no more than about five percent of the thickness, of said part of said wall.

75. The container of claim 68 wherein said second layer is softer than said first layer.

76. The container of claim 74 wherein one of the layers of said part of said wall other than said first layer includes a reground thermoplastic.

77. The container of claim 67 wherein said first layer has a density of at least about 0.960 gm./cc.

78. The container of claim 77 wherein said second layer has a density of at least about 0.005 gm./cc. less than said first layer.

79. The container of claim 78 wherein said first layer comprises at least about 50 percent of the thickness of said part of said wall.

80. The container of claim 79 wherein said second layer comprises no more than about 40 percent of the thickness of said part of said wall.

81. The container of claim 80 wherein said second layer has a density at least about 0.010 gm./cc. less than said first layer.

82. The container of claim 81 wherein said first layer comprises at least about 60 percent of the thickness of said part of said wall.

83. The container of claim 82 wherein said second layer comprises no more than about 25 percent of the thickness of said part of said wall.

84. The container of claim 83 wherein said first layer comprises at least about 75 percent of the thickness of said part of said wall.

85. The container of claim 84 wherein said second layer comprises no more than about 10 percent of the thickness of said part of said wall.

86. The container of claim 85 wherein one of the layers of said part of said wall other than said first layer includes a reground thermoplastic.

87. The container of claim 85 wherein said second layer has a density at least about 0.015 gm./cc. less than said first layer.

88. A container having a wall defining an interior and an exterior, at least a part of said wall comprising a plurality of layers including:
(A) a first thermoplastic layer; and
(B) a second thermoplastic layer less brittle than said first layer, said second layer occurring at the portion of said part of said wall wherever said first layer occurs and being located, at said portion, toward the exterior of said container, said second layer including stress concentrating areas.

89. The container of claim 88 wherein said first layer includes a polypropylene.

90. The container of claim 89 wherein said second layer includes a polyethylene or a polypropylene.

91. The container of claim 90 wherein said second layer includes a copolymer of ethylene or a copolymer of propylene.

92. The container of claim 90 wherein said second layer includes a copolymer of ethylene.

93. The container of claim 90 wherein said second layer includes a polypropylene.

94. The container of claim 90 wherein said second layer includes a polyethylene.

95. The container of claim 88 wherein said first layer includes a polyethylene.

96. The container of claim 95 wherein said second layer includes a polyethylene.

97. The container of claim 96 wherein said polyethylene of said first layer constitutes a high density polyethylene.

98. The container of claim 88 wherein said first and second layers are coextruded together.

99. The container of claim 98 wherein said second layer constitutes the exterior layer of said part of said wall.

100. The container of claim 99 wherein said first layer constitutes the inner layer of said part of said wall.

101. The container of claim 100 wherein said first and second layers constitute substantially all of said part of said wall.

102. The container of claim 100 further including an oxygen barrier layer between said first and second layers.

103. The container of claim 102 wherein said barrier layer comprises ethylene vinyl alcohol copolymer.

104. The container of claim 103 further comprising a first adhesive layer on one side of said barrier layer and a second adhesive layer on the other side of said barrier layer.

105. The container of claim 104 wherein said barrier layer and said first and second adhesive layers comprise no more than about five percent of the thickness of said part of said wall.

106. The container of claim 99 wherein said second layer is softer than said first layer.

107. The container of claim 105 wherein one of the layers of said part of said wall other than said first layer includes a reground thermoplastic.

108. The container of claim 97 wherein said first layer has a density of at least about 0.960 gm./cc.

109. The container of claim 108 wherein said second layer has a density of at least about 0.005 gm./cc. less than said first layer.

110. The container of claim 109 wherein said first layer comprises at least about 50 percent of the thickness of said part of said wall.

111. The container of claim 110 wherein said second layer comprises no more than about 40 percent of the thickness of said part of said wall.

112. The container of claim 111 wherein said second layer has a density at least about 0.010 gm./cc. less than said first layer.

113. The container of claim 112 wherein said first layer comprises at least about 60 percent of the thickness of said part of said wall.

114. The container of claim 113 wherein said second layer comprises no more than about 25 percent of the thickness of said part of said wall.

115. The container of claim 114 wherein said first layer comprises at least about 75 percent of the thickness of said part of said wall.

116. The container of claim 115 wherein said second layer comprises no more than about 10 percent of the thickness of said part of said wall

117. The container of claim 116 wherein one of the layers of said part of said wall other than said first layer includes a reground thermoplastic.

118. The container of claim 116 wherein said second layer has a density at least about 0.015 gm./cc. less than said first layer.

119. A container having a wall defining an interior and an exterior, at least a part of said wall comprising a plurality of layers including:
(A) a first thermoplastic layer composed of a polyethylene or a polypropylene; and
(B) a second thermoplastic layer composed of a polyethylene or a polypropylene, said second layer having a density at least about 0.002 gm./cc. less than said first layer, said second layer occurring at the portion of said part of said wall wherever said first layer occurs and being located, at said portion, toward the exterior of said container from said layer, said second layer comprising less than about one half of the thickness of said part of said wall.

120. The container of claim 119 wherein said first and second layers each includes a polypropylene.

121. The container of claim 119 wherein said first and second layers each includes a polyethylene and wherein said second layer has a density at least about 0.005 gm./cc. less than said first layer.

122. The container of claim 121 wherein said polyethylene of said first layer constitutes a high density polyethylene.

123. The container of claim 119 wherein said first and second layers are coextruded together.

124. The container of claim 123 wherein said second layer constitutes the exterior layer of said part of said wall.

125. The container of claim 124 wherein said first layer constitutes the inner layer of said part of said wall.

126. The container of claim 125 wherein said first and second layers constitute substantially all of said part of said wall.

127. The container of claim 125 further including an oxygen barrier layer between said first and second layers.

128. The container of claim 127 wherein said barrier layer comprises ethylene vinyl alcohol copolymer.

129. The container of claim 128 further comprising a first adhesive layer on one side of said barrier layer and a second adhesive layer on the other side of said barrier layer.

130. The container of claim 129 wherein said barrier layer and said first and second adhesive layers comprise no more than about five percent of the thickness of said part of said wall.

131. The container of claim 124 wherein said second layer is softer than said first layer.

132. The container of claim 130 wherein one of the layers of said part of said wall other than said first layer includes a reground thermoplastic.

133. The container of claim 122 wherein said first layer has a density of at least about 0.960 gm./cc.

134. The container of claim 133 further including an oxygen barrier layer between said first and second layers.

135. The container of claim 134 wherein said first layer comprises at least about 60 percent of the thickness of said part of said wall.

136. The container of claim 135 wherein said second layer comprises no more than about 25 percent of the thickness of said part of said wall.

137. The container of claim 136 wherein said second layer has a density at least about 0.010 gm./cc. less than said first layer.

138. The container of claim 137 wherein said first layer comprises at least about 75 percent of the thickness of said part of said wall.

139. The container of claim 138 wherein said second layer comprises no more than about 10 percent of the thickness of said part of said wall.

140. The container of claim 139 wherein one of the layers of said part of said wall other man said first layer includes a reground thermoplastic.

141. The container of claim 139 wherein said second layer has a density at least about 0.015 gm./cc. less than said first layer.

142. A container having a wall defining an interior and an exterior, at least a part of said wall comprising a plurality of layers including:
(A) a first thermoplastic layer composed of a polyethylene or a polypropylene; and
(B) a second thermoplastic layer composed of a polyethylene or a polypropylene, said second layer having a density at least about 0.002 gm./cc. less than said first layer, said second layer occurring at the portion of said part of said wall wherever said first layer occurs and being located, at said portion, toward the exterior of said container from said first layer, said first layer comprising more than about one tenth of the thickness of said part of said wall.

143. The container of claim 142 wherein said first and second layers each includes a polypropylene.

144. The container of claim 142 wherein said first and second layers each includes a polyethylene and wherein said second layer has a density at least about 0.005 gm./cc. less than said first layer.

145. The container of claim 144 wherein said polyethylene of said first layer constitutes a high density polyethylene.

146. The container of claim 142 wherein said first and second layers are coextruded together.

147. The container of claim 146 wherein said second layer constitutes the exterior layer of said part of said wall.

148. The container of claim 147 wherein said first layer constitutes the inner layer of said part of said wall.

149. The container of claim 148 wherein said first and second layers constitute substantially all of said part of said wall.

150. The container of claim 148 further including an oxygen barrier layer between said first and second layers.

151. The container of claim 150 wherein said barrier layer comprises ethylene vinyl alcohol copolymer.

152. The container of claim 151 further comprising a first adhesive layer on one side of said barrier layer and a second adhesive layer on the other side of said barrier layer.

153. The container of claim 152 wherein said barrier layer and said first and second adhesive layers comprise no more than about five percent of the thickness of said part of said wall.

154. The container of claim 147 wherein said second layer is softer than said first layer.

155. The container of claim 153 wherein one of the layers of said part of said wall other than said first layer includes a reground thermoplastic.

156. The container of claim 145 wherein said first layer has a density of at least about 0.960 gm./cc.

157. The container of claim 146 further including an oxygen barrier layer between said first and second layers.

158. The container of claim 156 wherein said first layer comprises at least about 50 percent of the thickness of said part of said wall.

159. The container of claim 158 wherein said second layer comprises no more than about 25 percent of the thickness of said part of said wall.

160. The container of claim 158 wherein said second layer has a density at least about 0.010 gm./cc. less than said first layer.

161. The container of claim 159 wherein said first layer comprises at least about 60 percent of the thickness of said part of said wall.

162. The container of claim 161 wherein said second layer comprises no more than about 10 percent of the thickness of said part of said wall.

163. The container of claim 159 wherein said first layer comprises at least about 75 percent of the thickness of said part of said wall.

164. The container of claim 163 wherein one of the layers of said part of said wall other than said first layer includes a reground thermoplastic.

165. The container of claim 163 wherein said second layer has a density at least about 0.015 gm./cc. less than said first layer.

166. A container having a wall defining an interior and an exterior, at least a part of said wall comprising a plurality of layers including:
(A) a first thermoplastic layer composed of a polyethylene or a polypropylene; and
(B) a second thermoplastic layer composed of a polyethylene or a polypropylene, said second layer having a density at least about 0.002 gm./cc. less than said first layer, said second layer occurring at the portion of said part of said wall wherever said first layer occurs and being located, at said portion, on the exterior of said container, said second layer including surface irregularities on said exterior.

167. The container of claim 166 wherein said first and second layers each includes a polypropylene.

168. The container of claim 166 wherein said first and second layers each includes a polyethylene and wherein said second layer has a density at least about 0.005 gm./cc. less than said first layer.

169. The container of claim 168 wherein said polyethylene of said first layer constitutes a high density polyethylene.

170. The container of claim 166 wherein said first and second layers are coextruded together.

171. The container of claim 170 wherein said first layer constitutes the inner layer of said part of said wall.

172. The container of claim 171 wherein said first and second layers constitute substantially all of said part of said wall.

173. The container of claim 171 further including an oxygen barrier layer between said first and second layers.

174. The container of claim 173 wherein said barrier layer comprises ethylene vinyl alcohol copolymer.

175. The container of claim 174 further comprising a first adhesive layer on one side of said barrier layer and a second adhesive layer on the other side of said barrier layer.

176. The container of claim 175 wherein said barrier layer and said first and second adhesive layers comprise no more than about five percent of the thickness of said part of said wall.

177. The container of claim 170 wherein said second layer is softer than said first layer.

178. The container of claim 176 wherein one of the layers of said part of said wall other than said first layer includes a reground thermoplastic.

179. The container of claim 169 wherein said first layer has a density of at least about 0.960 gm./cc.

180. The container of claim 179 further including an oxygen barrier layer between said first and second layers.

181. The container of claim 179 wherein said first layer comprises at least about 50 percent of the thickness of said part of said wall.

182. The container of claim 181 wherein said second layer comprises no more than about 40 percent of the thickness of said part of said wall.

183. The container of claim 182 wherein said second layer has a density at least about 0.010 gm./cc. less than said first layer.

184. The container of claim 183 wherein said first layer comprises at least about 60 percent of the thickness of said part of said wall.

185. The container of claim 184 wherein said second layer comprises no more than about 25 percent of the thickness of said part of said wall.

186. The container of claim 165 wherein said first layer comprises at least about 75 percent of the thickness of said part of said wall.

187. The container of claim 186 wherein said second layer comprises no more than about 10 percent of the thickness of said part of said wall.

188. The container of claim 187 wherein one of the layers of said part of said wall other than said first layer includes a reground thermoplastic.

189. The container of claim 187 wherein said second layer has a density at least about 0.015 gm./cc. less than said first layer.

190. A container having a wall defining an interior and an exterior, at least a part of said wall comprising a plurality of layers including:
(A) a first thermoplastic layer composed of a polyethylene or a polypropylene; and
(B) a second thermoplastic layer composed of a polyethylene or a polypropylene, said second layer having a density at least about 0.002 gm./cc. less than said first layer, said second layer occurring at the portion of said part of said wall wherever said first layer occurs and being located, at said portion, toward the exterior of said container, said second layer including stress concentrating areas.

191. The container of claim 190 wherein said first and second layers each includes a polypropylene.

192. The container of claim 190 wherein said first second layers each includes a polyethylene and wherein said second layer has a density at least about 0.005 gm./cc. less than said first layer.

193. The container of claim 192 wherein said polyethylene of said first layer constitutes a high density polyethylene.

194. The container of claim 190 wherein said first and second layers are coextruded together.

195. The container of claim 194 wherein said second layer constitutes the exterior layer of said part of said wall.

196. The container of claim 195 wherein said first layer constitutes the inner layer of said part of said wall.

197. The container of claim 196 wherein said first and second layers constitute substantially all of said part of said wall.

198. The container of claim 196 further including an oxygen barrier layer between said first and second layers.

199. The container of claim 198 wherein said barrier layer comprises ethylene vinyl alcohol copolymer.

200. The container of claim 199 further comprising a first adhesive layer on one side of said barrier layer and a second adhesive layer on the other side of said barrier layer.

201. The container of claim 200 wherein said barrier layer and said first and second adhesive layers comprise no more than about five percent of the thickness of said part of said wall.

202. The container of claim 195 wherein said second layer is softer than said first layer.

203. The container of claim 201 wherein one of the layers of said part of said wall other than said first layer includes a reground thermoplastic.

204. The container of claim 193 wherein said first layer has a density of at least about 0.960 gm./cc.

205. The container of claim 204 further including an oxygen barrier layer between said first and second layers.

206. The container of claim 204 wherein said first layer comprises at least about 50 percent of the thickness of said part of said wall.

207. The container of claim 206 wherein said second layer comprises no more than about 40 percent of the thickness of said part of said wall.

208. The container of claim 205 wherein said second layer has a density at least about 0.010 gm./cc. less than said first layer.

209. The container of claim 208 wherein said first layer comprises at least about 60 percent of the thickness of said part of said wall.

210. The container of claim 209 wherein said second layer comprises no more than about 25 percent of the thickness of said part of said wall.

211. The container of claim 210 wherein said first layer comprises at least about 75 percent of the thickness of said part of said wall.

212. The container of claim 211 wherein said second layer comprises no more than about 10 percent of the thickness of said part of said wall.

213. The container of claim 212 wherein one of the layers of said part of said wall other than said first layer includes a reground thermoplastic.

214. The container of claim 212 wherein said second layer has a density at least about 0.015 gm./cc. less than said first layer.

215. A method for making a container comprising molding a container having a wall defining an interior and an exterior, said molding including:
(A) forming a first thermoplastic layer of at least part of said wall; and
(B) forming at said part of said wall a second thermoplastic layer less brittle than said first layer, said second layer being formed at the portion of said wall wherever said first layer occurs and toward the exterior of said container from said first layer, said second layer comprising less than about one half of the thickness of said part of said wall.

216. The method of claim 215 wherein said first layer is formed from a polypropylene.

217. The method of claim 216 wherein said second layer is formed from a polyethylene or a polypropylene.

218. The method of claim 217 wherein said second layer is formed from a copolymer of ethylene or a copolymer of propylene.

219. The method of claim 218 wherein said second layer is formed from a copolymer of ethylene.

220. The method of claim 217 wherein said second layer is formed from a polypropylene.

221. The method of claim 217 wherein said second layer is formed from a polyethylene.

222. The method of claim 215 wherein said first layer is formed from a polyethylene.

223. The method of claim 222 wherein said second layer is formed from a polyethylene.

224. The method of claim 215 wherein said first and second layers are formed by being coextruded together.

225. The method of claim 224 wherein said first layer is formed as the inner layer of said part of said wall.

226. The method of claim 225 further including forming an oxygen barrier layer between said first and second layers.

227. The method of claim 226 wherein said barrier layer comprises ethylene vinyl alcohol copolymer.

228. The method of claim 227 further including forming first and second adhesive layers on either side of said barrier layer and wherein said barrier layer and said first and second adhesive layers comprise no more than about five percent of the thickness of said part of said wall.

229. The method of claim 224 wherein said second layer is softer than said first layer.

230. The method of claim 229 further including incorporating in one of the layers of said part of said wall other than said first layer a reground thermoplastic.

231. The method of claim 223 wherein said first layer is formed from a thermoplastic having a density of at least about 0.960 gm./cc.

232. The method of claim 231 wherein said second layer is formed from a thermoplastic having a density of at least about 0.005 gm./cc. less than said first layer.

233. The method of claim 232 wherein said first layer is formed to comprise at least about 75 percent of the thickness of said part of said wall.

234. The method of claim 233 wherein said second layer is formed to comprise no more than about 10 percent of the thickness of said part of said wall.

235. The method of claim 234 wherein said second layer is formed from a thermoplastic having a density at least about 0.015 gm./cc. less than said first layer.

236. A method for making a container comprising molding a container having a wall defining an interior and an exterior, said molding including:
(A) forming a first thermoplastic layer of at least part of said wall; and
(B) forming at said part of said wall a second thermoplastic layer less brittle than said first layer, said second layer being formed at the portion of said part of said wall wherever said first layer occurs and toward the exterior of said container from said first layer, said first layer comprising more than about one tenth of the thickness of said part of said wall.

237. The method of claim 234 wherein said first layer is formed from a thermoplastic including a polypropylene.

238. The method of claim 237 wherein said second layer is formed from a thermoplastic including a thermoplastic selected from the group consisting of polyethylene, polypropylene, and a copolymer of polyethylene and polypropylene.

239. The method of claim 238 wherein said second layer is formed from a thermoplastic including a copolymer of polyethylene and polypropylene.

240. The method of claim 238 wherein said copolymer has a higher concentration of polyethylene than polypropylene.

241. The method of claim 238 wherein said thermoplastic is polypropylene.

242. The method of claim 238 wherein said thermoplastic is polyethylene.

243. The method of claim 242 wherein said first layer is formed from a thermoplastic including a polyethylene.

244. The method of claim 243 wherein said second layer is formed from a thermoplastic include a polyethylene.

245. The method of claim 236 wherein said first and second layers are formed by being coextruded together.

246. The method of claim 245 wherein said first layer is formed as the inner layer of said part of said wall.

247. The method of claim 246 further including forming an oxygen barrier layer between said first and second layers.

248. The method of claim 247 wherein said barrier layer comprises ethylene vinyl alcohol copolymer.

249. The method of claim 248 further including forming first and second adhesive layers on either side of said barrier layer and wherein said barrier layer and said first and second adhesive layers comprise no more than about five percent of the thickness of said part of said wall.

250. The method of claim 245 wherein said second layer is softer than said first layer.

251. The method of claim 250 further including incorporating in one of the layers of said part of said wall other than said first layer a reground thermoplastic.

252. The method of claim 245 wherein said first layer is formed from a thermoplastic having a density of at least about 0.960 gm./cc.

253. The method of claim 245 wherein said second layer is formed from a thermoplastic having a density of at least about 0.005 gm./cc. less than said first layer.

254. The method of claim 253 wherein said first layer is formed to comprise at least about 50 percent of the thickness of said part of said wall.

255. The method of claim 254 wherein said second layer is formed to comprise no more than about 10 percent of the thickness of said part of said wall.

256. The method of claim 254 wherein said first layer is formed to comprise at least about 75 percent of the thickness of said part of said wall.

257. The method of claim 254 wherein said second layer is formed from a thermoplastic having a density at least about 0.015 gm./cc. less than said first layer.

258. A method for making a container comprising molding a container having a wall defining an interior and an exterior, said molding including:
(A) forming a first thermoplastic layer of at least part of said wall; and
(B) forming at said part of said wall a second thermoplastic layer less brittle than said first layer, said second layer being formed at the portion of said part of said wall wherever said first layer occurs and on the exterior of said container from said first layer, said second layer including surface irregularities on said exterior.

259. The method of claim 258 wherein said first layer is formed from a polypropylene.

260. The method of claim 259 wherein said second layer is formed from a polyethylene or a polypropylene.

261. The method of claim 260 wherein said second layer is formed from a copolymer of ethylene or a copolymer of propylene.

262. The method of claim 260 wherein said second layer is formed from a copolymer of ethylene.

263. The method of claim 260 wherein said second layer is formed from a polypropylene.

264. The method of claim 260 wherein said second layer is formed from a polyethylene.

265. The method of claim 258 wherein said first layer is formed from a polyethylene.

266. The method of claim 265 wherein said second layer is formed from a polyethylene.

267. The method of claim 258 wherein said first and second layers are formed by being coextruded together.

268. The method of claim 267 wherein said first layer is formed as the inner layer of said part of said wall.

269. The method of claim 268 further including forming an oxygen barrier layer between said first and second layers.

270. The method of claim 269 wherein said barrier layer comprises ethylene vinyl alcohol copolymer.

271. The method of claim 270 further including forming first and second adhesive layers on either side of said barrier layer and wherein said barrier layer and said first and second adhesive layers comprise no more than about five percent of the thickness of said part of said wall.

272. The method of claim 267 wherein said second layer is softer than said first layer.

273. The method of claim 272 further including incorporating in one of the layers of said part of said wall other than said first layer a reground thermoplastic.

274. The method of claim 267 wherein said first layer is formed from a thermoplastic having a density of at least about 0.960 gm./cc.

275. The method of claim 274 wherein said second layer is formed from a thermoplastic having a density of at least about 0.005 gm./cc. less than said first layer.

276. The method of claim 275 wherein said first layer is formed to comprise at least about 50 percent of the thickness of said part of said wall.

277. The method of claim 276 wherein said first layer is formed to comprise at least about 75 percent of the thickness of said part of said wall and said second layer is formed to comprise no more than about 10 percent of the thickness of said part of said wall.

278. The method of claim 277 wherein said second layer is formed to comprise no more than about 10 percent of the thickness of said part of said wall.

279. The method of claim 278 wherein said second layer is formed from a thermoplastic having a density at least about 0.015 gm./cc. less than said first layer.

280. A method for making a container comprising molding a container having a wall defining an interior and an exterior, said molding including:
(A) forming a first thermoplastic layer of at least part of said wall; and
(B) forming at said part of said wall a second thermoplastic layer less brittle than said first layer, said second layer being formed at the portion of said part of said wall wherever said first layer occurs and toward the exterior of said container from said first layer, said second layer including stress concentrating areas.

281. The method of claim 280 wherein said first layer is formed from a polypropylene.

282. The method of claim 281 wherein said second layer is formed from a polyethylene or a polypropylene.

283. The method of claim 282 wherein said second layer is formed from a copolymer of ethylene or a copolymer of propylene.

284. The method of claim 282 wherein said second layer is formed from a copolymer of ethylene.

285. The method of claim 282 wherein said second layer is formed from a polypropylene.

286. The method of claim 282 wherein said second layer is formed from a polyethylene.

287. The method of claim 280 wherein said first layer is formed from a polyethylene.

288. The method of claim 287 wherein said second layer is formed from a polyethylene.

289. The method of claim 280 wherein said first and second layers are formed by being coextruded together.

290. The method of claim 289 wherein said first layer is formed as the inner layer of said part of said wall.

291. The method of claim 290 further including forming an oxygen barrier layer between said first and second layers.

292. The method of claim 291 wherein said barrier layer comprises ethylene vinyl alcohol copolymer.

293. The method of claim 292 further including forming first and second adhesive layers on either side of said barrier layer and wherein said barrier layer and said first and second adhesive layers comprise no more than about five percent of the thickness of said part of said wall.

294. The method of claim 289 wherein said second layer is softer than said first layer.

295. The method of claim 294 further including incorporating in one of the layers of said part of said wall other than said first layer a reground thermoplastic.

296. The method of claim 289 wherein said first layer is formed from a thermoplastic having a density of at least about 0.960 gm./cc.

297. The method of claim 296 wherein said second layer is formed from a thermoplastic having a density of at least about 0.005 gm./cc. less than said first layer.

298. The method of claim 297 wherein said first layer is formed to comprise at least about 50 percent of the thickness of said part of said wall.

299. The method of claim 298 wherein said second layer is formed to comprise no more than about 40 percent of the thickness of said part of said wall.

300. The method of claim 299 wherein said first layer is formed to comprise at least about 75 percent of the thickness of said part of said wall.

301. The method of claim 300 wherein said second layer is formed to comprise no more than about 10 percent of the thickness of said part of said wall.

302. The method of claim 301 wherein said second layer is formed from a thermoplastic having a density at least about 0.015 gm./cc. less than said first layer.

303. A method for making a container comprising molding a container having a wall defining an interior and an exterior, said molding including:
(A) forming a first thermoplastic layer of at least part of said wall, said first thermoplastic layer being composed of a polyethylene or a polypropylene; and
(B) forming at said part of said wall a second thermoplastic layer composed of a polyethylene or a polypropylene, said second layer having a density at least about 0.002 gm./cc. less than said first layer, said second layer being formed at the portion of said part of said wall wherever said first layer occurs and toward the exterior of said container from said first layer, said second layer comprising less than about one half of the thickness of said part of said wall.

304. The method of claim 303 wherein said first and second layers are each formed from a polypropylene.

305. The method of claim 304 wherein said first and second layers are each formed from a polyethylene and wherein said second layer has a density at least about 0.005 gm./cc. less than said first layer.

306. The method of claim 303 wherein said first and second layers are formed by being coextruded together.

307. The method of claim 306 wherein said first layer is formed as the inner layer of said part of said wall.

308. The method of claim 307 further including forming an oxygen barrier layer between said first and second layers.

309. The method of claim 308 wherein said barrier layer comprises ethylene vinyl alcohol copolymer.

310. The method of claim 309 further including forming first and second adhesive layers on either side of said barrier layer and wherein said barrier layer and said first and second adhesive layers comprise no more than about five percent of the thickness of said part of said wall.

311. The method of claim 306 wherein said second layer is softer than said first layer.

312. The method of claim 311 further including incorporating in one of the layers of said part of said wall other than said first layer a reground thermoplastic.

313. The method of claim 306 wherein said first layer is formed from a thermoplastic having a density of at least about 0.960 gm./cc.

314. The method of claim 313 wherein said first layer is formed to comprise at least about 75 percent of the thickness of said part of said wall.

315. The method of claim 314 wherein said second layer is formed to comprise no more than about 10 percent of the thickness of said part of said wall.

316. The method of claim 315 wherein said second layer is formed from a thermoplastic having a density at least about 0.015 gm./cc. less than said first layer.

317. A method for making a container comprising molding a container having a wall defining an interior and an exterior, said molding including:
(A) forming a first thermoplastic layer of at least part of said wall, said first thermoplastic layer being composed of polyethylene or a polypropylene; and
(B) forming at said part of said wall a second thermoplastic layer composed of a polyethylene or a polypropylene, said second layer having a density at least about 0.002 gm./cc. less than said first layer, said second layer being formed at the portion of said part of said wall wherever said first layer occurs and toward the exterior of said container from said first layer, said first layer comprising more than about one tenth of the thickness of said part of said wall.

318. The method of claim 317 wherein said first and second layers are each formed from a polypropylene.

319. The method of claim 318 wherein said first and second layers are each formed from a polyethylene and wherein said second layer has a density at least about 0.005 gm./cc. less than said first layer.

320. The method of claim 317 wherein said first and second layers are formed by being coextruded together.

321. The method of claim 320 wherein said first layer is formed as the inner layer of said part of said wall.

322. The method of claim 321 further including forming an oxygen barrier layer between said first and second layers.

323. The method of claim 322 wherein said barrier layer comprises ethylene vinyl alcohol copolymer.

324. The method of claim 323 further including forming first and second adhesive layers on either side of said barrier layer and wherein said barrier layer and said first and second adhesive layers comprise no more than about five percent of the thickness of said part of said wall.

325. The method of claim 320 wherein said second layer is softer than said first layer.

326. The method of claim 325 further including incorporating in one of the layers of said part of said wall other than said first layer a reground thermoplas tic.

327. The method of claim 320 wherein said first layer is formed from a thermoplastic having a density of at least about 0.960 gm./cc.

328. The method of claim 327 wherein said first layer is formed to comprise at least about 50 percent of the thickness of said part of said wall.

329. The method of claim 328 wherein said second layer is formed to comprise no more than about 10 percent of the thickness of said part of said wall.

330. The method of claim 328 wherein said first layer is formed to comprise at least about 75 percent of the thickness of said part of said wall.

331. The method of claim 330 wherein said second layer is formed from a thermoplastic having a density at least about 0.015 gm./cc. less than said first layer.

332. A method for making a container comprising molding a container having a wall defining an interior and an exterior, said molding including:
(A) forming a first thermoplastic layer of at least part of said wall, said first thermoplastic layer being composed of a polyethylene or a polypropylene; and
(B) forming at said part of said wall a second thermoplastic layer composed of a polyethylene or a polypropylene, said second layer having a density at least about 0.002 gm./cc. less than said first layer, said second layer being formed at the portion of said part of said wall wherever said first layer occurs and on the exterior of said container from said first layer, said second layer including surface irregularities on said exterior.

333. The method of claim 332 wherein said first and second layers are each formed from a polypropylene.

334. The method of claim 333 wherein said first and second layers are each formed from a polyethylene and wherein said second layer has a density at least about 0.005 gm./cc. less than said first layer.

335. The method of claim 332 wherein said first and second layers are formed by being coextruded together.

336. The method of claim 335 wherein said first layer is formed as the inner layer of said part of said wall.

337. The method of claim 336 further including forming an oxygen barrier layer between said first and second layers.

338. The method of claim 337 wherein said barrier layer comprises ethylene vinyl alcohol copolymer.

339. The method of claim 338 further including forming first and second adhesive layers on either side of said barrier layer and wherein said barrier layer and said first and second adhesive layers comprise no more than about five percent of the thickness of said part of said wall.

340. The method of claim 335 wherein said second layer is softer than said first layer.

341. The method of claim 340 further including incorporating in one of the layers of said part of said wall other than said first layer a reground thermoplastic.

342. The method of claim 335 wherein said first layer is formed from a thermoplastic having a density of at least about 0.960 gm./cc.

343. The method of claim 342 wherein said first layer is formed to comprise at least about 50 percent of the thickness of said part of said wall.

344. The method of claim 343 wherein said second layer is forced to comprise no more than about 40 percent of the thickness of said part of said wall.

345. The method of claim 344 wherein said first layer is formed to comprise at least about 75 percent of the thickness of said part of said wall.

346. The method of claim 345 wherein said second layer is formed to comprise no more than about 10 percent of the thickness of said part of said wall

347. The method of claim 346 wherein said second layer is formed from a thermoplastic having a density at least about 0.015 gm./cc. less than said first layer.

348. A method for making a container comprising molding a container having a wall defining an interior and an exterior, said molding including:
(A) forming a first thermoplastic layer of at least part of said wall, said first thermoplastic layer being composed of a polyethylene or a polypropylene; and
(B) forming at said part of said wall a second thermoplastic layer composed of a polyethylene or a polypropylene, said second layer having a density at least about 0.002 gm./cc. less than said first layer, said second layer being formed at the portion of said part of said wall wherever said first layer occurs and toward the exterior of said container from said first layer, said second layer including stress concentrating areas.

349. The method of claim 349 wherein said first and second layers are each formed from a polypropylene.

350. The method of claim 349 wherein said first and second layers are each formed from a polyethylene.

351. The method of claim 348 wherein said first and second layers are formed by being coextruded together.

352. The method of claim 351 wherein said first layer is formed as the inner layer of said part of said wall.

353. The method of claim 352 further including forming an oxygen barrier layer between said first and second layers.

354. The method of claim 353 wherein said barrier layer comprises ethylene vinyl alcohol copolymer.

355. The method of claim 354 further including forming first and second adhesive layers on either side of said barrier layer and wherein said barrier layer and said first and second adhesive layers comprise no more than about five percent of the thickness of said part of said wall.

356. The method of claim 351 wherein said second layer is softer than said first layer.

357. The method of claim 356 further including incorporating in one of the layers of said part of said wall other than said first layer a reground thermoplastic.

358. The method of claim 351 wherein said first layer is formed from a thermoplastic having a density of at least about 0.960 gm./cc.

359. The method of claim 358 wherein said first layer is formed to comprise at least about 50 percent of the thickness of said part of said wall.

360. The method of claim 359 wherein said second layer is formed to comprise no more than about 40 percent of the thickness of said part of said wall.

361. The method of claim 358 wherein said first layer is formed to comprise at least about 75 percent of the thickness of said part of said wall.

362. The method of claim 361 wherein said second layer is formed to comprise no more than about 10 percent of the thickness of said part of said wall.

363. The method of claim 362 wherein said second layer is formed from a thermoplastic having a density at least about 0.015 gm./cc. less than said first layer.
